(19) United States
(12) Patent Application Publication
(10) Pub. No.: US 2002/0031393 A1
(43) Pub. Date: Mar. 14, 2002

(54) Cap fixing construction

(76) Inventor: Juri Saito, Kawagoe-shi (JP)

Correspondence Address: MCGINN & GIBB, PLLC, 8321 OLD COURTHOUSE ROAD, SUITE 200, VIENNA, VA, 22182-3817, US

(21) Appl. No.: 09/771,680

(22) Filed: Jan. 30, 2001

(30) Foreign Application Priority Data
Aug. 18, 2000 (JP) 2000-248779

(51) Int. Cl. B43K 23/12; B43K 21/22; B43K 21/16

(52) U.S. Cl. 401/243; 401/65; 401/92

(57) ABSTRACT

A cap fixing construction for mounting a cap on a barrel, includes a slit formed in the cap and extending in an axial direction from an end of the cap, and a longitudinal rib formed on the barrel and extending in the axial direction, so that the cap is fixed on the barrel by fitting the longitudinal rib in the slit.

### BACKGROUND OF THE INVENTION

1. Field of the Invention

The present invention relates to a cap fixing construction for fixing a cap on a barrel of a writing instrument.

2. Description of the Related Art

A conventional cap fixing construction of this type, has been described, for example, in Japanese Patent Laid-Open Application No. 10-71796 or Japanese Patent Laid-Open Application No. 9-234989.

In the cap fixing construction described in Japanese Patent Laid-Open Application No. 10-71796, either one of a barrel and a cap is formed with an inclined engaging portion, and the other of the barrel and the cap is formed with a receiving portion engaging the inclined engaging portion. The engaging portion or receiving portion formed in the cap is formed on the inside surface thereof. Thus, the cap is fixed on the barrel by the engaging portion engaging the receiving portion. When the cap is to be removed from the barrel, the cap is rotated relatively to the barrel, by which the cap is separated from the barrel with the engaging portion slidably contacting the receiving portion, and thereby the cap can be removed.

Also, in the cap fixing construction described in Japanese Patent Laid-Open Application No. 9-234989, a triangular protrusion, inclining at 45 degrees and projecting rearwardly beyond a rear outer step of a barrel is formed on the peripheral surface of the barrel. An annular groove is formed in the rear peripheral surface of the barrel beyond the rear outer step.

On the inner peripheral surface of a rear shaft constituting a cap, an annular inside protrusion is formed for being fitted in the groove in the barrel. Also, a notch having the same shape as that of the protrusion on the barrel is formed at the tip end of the rear shaft. The inside protrusion of the cap is fitted in the groove in the barrel, and the same shaped notch is engaged with the triangular protrusion on the barrel, thereby fixing the cap on the barrel. When the cap is to be removed from the barrel, the cap is rotated relatively to the barrel, thereby separating the cap from the barrel with the protrusion slidably contacting the notch, and thereby removing the cap.

However, in the cap fixing construction described in the above-mentioned Japanese Patent Laid-Open Application No. 10-71796, the engaging portion or the receiving portion is formed on the inside surface of the cap, which is problematic in that the engaging portion or the receiving portion is invisible from the outside, so that the cap mounting operation is difficult.

Also, it is difficult to provide a restraining force for restraining the cap with respect to the barrel only by the slidable contact between the inclined surfaces of the inclined engaging portion and the inclined receiving portion. Thus, this construction is insufficient for restraining the cap with respect to the barrel. The only solution to this problem is to decrease a difference between the inside diameter of the cap and the outside diameter of the barrel, thereby to enhance a frictional resistance between the cap's inside surface and the barrel's outside surface, by which the cap is fixed on the barrel. However, resistance is provided by the entire contact surface between the cap and the barrel when the cap is mounted, thereby providing poor operability.

Further, in the cap fixing construction described in the above-mentioned Japanese Patent Laid-Open Application No. 9-234989, the cap is restrained with respect to the barrel by the fitting of the annular inside protrusion of the cap in the annular groove of the barrel. Therefore, resistance is high when fixing or unfixing the cap, thereby making it difficult to mount or remove the cap.

Also, both constructions described above are unsuitable for being used commonly for writing instruments of different types. For example, when the construction is applied to a mechanical pencil, the cap is generally detachable from the barrel to replenish leads or for other purposes. Contrarily, when the construction is applied to a ball-point pen, the cap need not be detachable from the barrel because a refill is generally replaced by removing a tip-end element on the tip end side of the barrel, and the cap is preferably undetachable from the barrel to prevent the cap from being lost or for other reasons. Thus, it is difficult to apply the cap fixing construction commonly to a mechanical pencil and a ball-point pen.

### SUMMARY OF THE INVENTION

In view of the foregoing and other drawbacks, disadvantages and problems of the conventional methods and structures, a first object of the present invention is to provide a cap fixing construction that makes easy mounting a cap on a barrel.

Another object of the present invention is to provide a cap fixing construction that enables the same cap and barrel to be used commonly for writing instruments in which the cap is detachable and undetachable from the barrel.

To achieve the above objects, the present invention provides a cap fixing construction for fixing a cap on a barrel of a writing instrument, in which one of the barrel and the cap is formed with a slit extending in an axial direction from the end thereof, and the other of the barrel and the cap is formed with a longitudinal rib extending in the axial direction, so that the cap is fixed on the barrel by fitting the longitudinal rib in the slit. With this construction, a user or a worker can mount the cap on the barrel while viewing the slit, so that the mounting operation is made easy. Also, by fitting the longitudinal rib in the slit, the fitting length in the axial direction can be made long, so that the fitting force can be stabilized.

A clip may be formed integrally with the cap and extend from the peripheral surface of the cap to the barrel, and a position where the longitudinal rib may be fitted in the slit is arranged on the back face side of the clip. Since the position where the longitudinal rib is fitted in the slit is hidden by the clip, the writing instrument's appearance is not marred. Also, the clip can be operated as a guide in the mounting operation.

At least one window hole may be formed in the peripheral surface of either one of the barrel and the cap, and at least one protrusion lightly engaged with the window hole may be provided on the other of the barrel and the cap. The light engagement of the at least one protrusion with the at leaast one window hole can further stabilize the fitting force between the cap and the barrel.

The engagement position of the at least one protrusion with the at least one window hole may be aligned with the fitting position of the longitudinal rib in the slit in a circumferential direction of the barrel and the cap. By aligning the engagement position with the fitting position, the fitting force between the cap and the barrel can be stabilized further.

An engaged portion for engaging an engaging portion formed at a part of an internal mechanism projecting from the end of the barrel may be formed on the inside surface of the cap. By engaging the engaged portion of the cap with the engaging portion of the internal mechanism, the cap can be mounted nondetachably on the barrel via the internal mechanism. Regardless of the cap being detachable or undetachable from the barrel, the same cap and barrel can be used commonly.

An extending portion of an internal mechanism is preferably projected from the end of the barrel, an engaging portion may be formed at the projected extending portion, and an engaged portion may be formed on the inside surface of the cap to firmly fit to the engaging portion. By engaging the engaged portion of the cap with the engaging portion of the extending portion of the internal mechanism, the cap can be mounted nondetachably on the barrel via the internal mechanism. Regardless of the cap being detachable or undetachable from the barrel, the same cap and barrel can be used commonly.

At least one window hole may be formed in the barrel, and at least one elastic protrusion which is engaged with the at least one window hole and is capable of being elastically displaced in the radial direction may be provided at a part of the internal mechanism. Thus, the internal mechanism can be fixed surely to the barrel. The window hole with which the elastic protrusion is engaged can be one with which the protrusion provided on the cap is lightly engaged.

The present disclosure relates to subject matter contained in Japanese Patent Application No. 2000-248779, filed on Aug. 18, 2000, which is expressly incorporated herein by reference in its entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 is a longitudinal sectional view showing a first embodiment in which a fixing construction for a barrel 12 and a cap 20 according to the present invention is applied to a mechanical pencil 10;

FIG. 2 is a plan view of the barrel 12 according to the present invention;

FIG. 3 is a sectional view taken along line 3-3 of FIG. 2 showing the barrel 12;

FIG. 4 is a sectional view of the barrel 12 in a state in which the barrel 12 is rotated through 90° degrees from the state shown in FIG. 3 about an axis of the barrel 12;

FIG. 5 is a front view of the cap 20 according to the present invention;

FIG. 6 is a sectional view taken along line 6-6 of FIG. 5;

FIG. 7 is a sectional view of the cap 20 in which the cap 20 is rotated through 90° degrees from the state shown in FIG. 6 about the an axis of the cap 20;

FIG. 8 is an enlarged sectional view of the fixing construction for the barrel 12 and the cap 20 shown in FIG. 1;

FIG. 9 is a sectional view of the barrel 12 and the cap 20, which is taken along line 9-9 of FIG. 8;

FIG. 10 is a longitudinal sectional view showing a second embodiment in which a fixing construction for a barrel 12 and a cap 20 according to the present invention is applied to a ball-point pen 40;

FIG. 11 is a longitudinal sectional view of a cam body 64 of the fixing construction of FIG. 10;

FIG. 12 is a plan view of the cam body 64 of FIG. 11;

FIG. 13 is an enlarged sectional view of the fixing construction for the barrel 12 and the cap 20 shown in FIG. 10; and

FIG. 14 is a sectional view of the barrel 12, the cap 20, and the cam body 64, which is taken along line 14-14 of FIG. 13.

### DETAILED DESCRIPTION OF THE PREFERRED EMBODIMENTS

Embodiments of the present invention will now be described with reference to the accompanying drawings.

First Embodiment

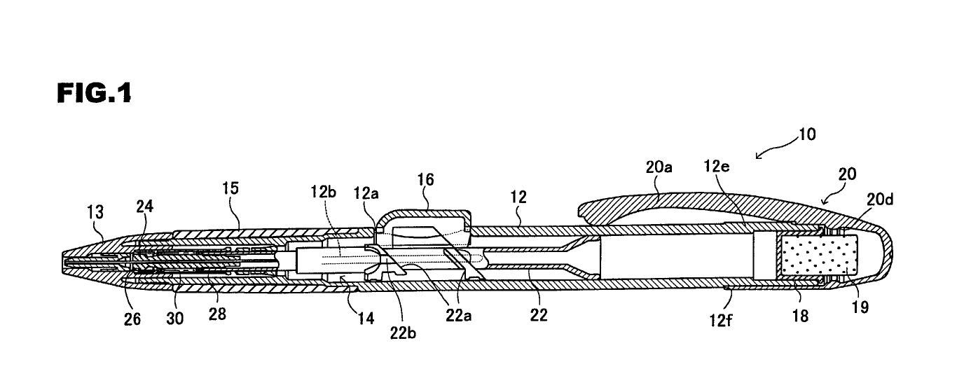

FIG. 1 shows a first embodiment in which a fixing construction for a barrel and a cap according to the present invention is applied to a mechanical pencil.

In FIG. 1, a side knock type mechanical pencil 10 is shown mainly having a barrel 12, a lead feeding mechanism 14 disposed in the barrel 12, a knock operating portion 16 attached swayably to an opening 12a formed in a side central portion of the barrel 12, an eraser holder 18 with an eraser 19, which is fitted detachably in the rear end portion of the barrel 12, and a cap 20 fixed detachably to the rear end portion of the barrel 12.

At the tip end of the barrel 12, a tip-end element 13 is provided, which is screwed (e.g., threaded) in the body of the barrel 12. The tip-end element 13 can be integrally formed with the body of the barrel 12. A rubber gripper 15 is fitted around the outer peripheral portion of the barrel 12, which positionally correspond to a portion of the barrel which is to be gripped by a user. The lead feeding mechanism 14 has a well-known configuration including a joint 22 provided with a cam portion 22a for being advanced in the axial direction by a swaying operation of the knock operating portion 16. A chuck 24, whose rear end is pressed in the tip end portion of the joint 22, tightens and feeds a lead, and a chuck ring 26, which is mounted around the chuck 24, tightens the chuck 24. A sleeve 28, which is fixed to the barrel 12, regulates the rearward movement of the chuck ring 26, and a chuck spring 30, which is an elastic element disposed between the sleeve 28 and the joint 22, urges the joint 22 and the chuck 24 rearwardly. Longitudinal grooves 22b, 22b are formed at both sides of the cam portion 22a of the joint 22. The longitudinal grooves 22b, 22b engage longitudinal ribs 12b, 12b (see FIGS. 3 and 4) provided on the inside surface of the barrel 12. Therefore, the joint 22 is incapable of being rotated and capable of being moved in the axial direction relatively to the barrel 12.

When the knock operating portion 16 is knocked, the joint 22 is advanced by the cam portion 22a subjected to the swaying operation of the knock operating portion 16. At the same time, the chuck 24 advances, by which a predetermined amount of lead is extended. A detailed description of this mechanism and its operation is omitted because they are well known.

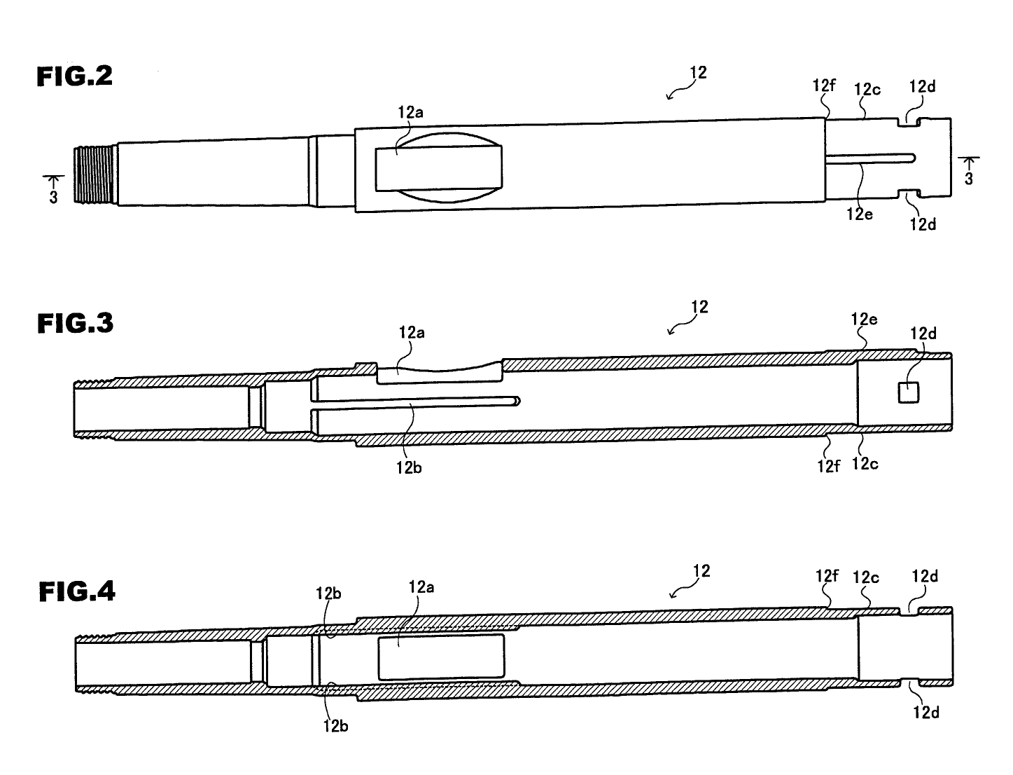

The rear end portion of the barrel 12 has a decreased-diameter portion 12c having a smaller diameter than that of the central portion of the barrel 12, as shown in FIGS. 2 to 4. The peripheral surface of the decreased-diameter portion 12c is formed with two window holes 12d, 12d disposed approximately 180° apart from each other in the circumferential direction. Further, a longitudinal rib 12e is provided at a position approximately 90° apart from the two window holes 12d, 12d. The longitudinal rib 12e extends to a step face 12f at the tip end of the decreased-diameter portion 12c.

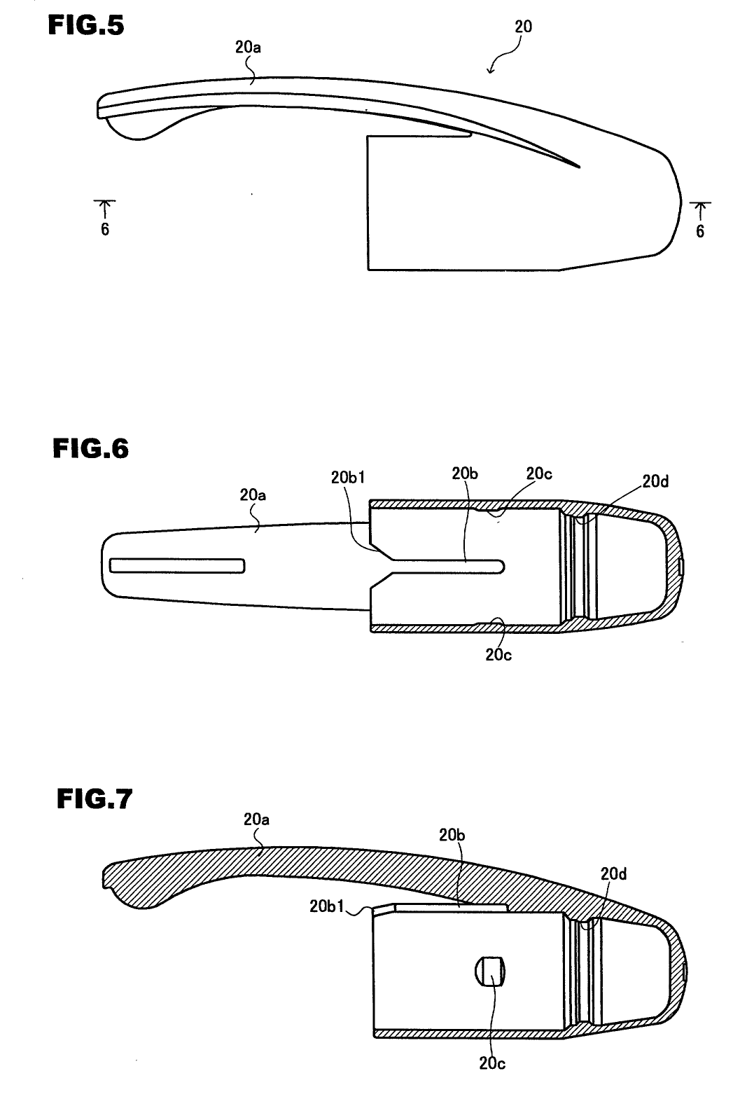

As shown in FIGS. 5 to 7, the cap 20 fixed at the rear end portion of the barrel is preferably integrally formed with a clip 20a extending from the peripheral surface of the cap 20 to the barrel 12. An axially extending slit 20b is formed in a portion of the cap 20 which is opposed or faces to the back side of the clip 20a.

Further, at positions of the cap 20 which are approximately 90° apart from the both sides of the slit 20b in the circumferential direction, two protrusions 20c , 20c projecting in the inside diameter direction are provided. The projection amount in the inside diameter direction of the protrusions 20c, 20c is relatively small. The slit 20b extends from the axial tip end of a body of the cap 20 to a position of the cap body which positionally corresponds in the circumferential direction to the positions of the cap body at which the protrusions 20c, 20c are provided. The tip end of the slit 20b is formed with a taper portion 20b1 in which a slit width increases toward the tip end, as best shown in FIG. 6. At an inner portion of the cap body in the rear of the protrusions 20c, 20c, an annular protrusion 20d (engaged portion), which is described below in a second embodiment, is provided.

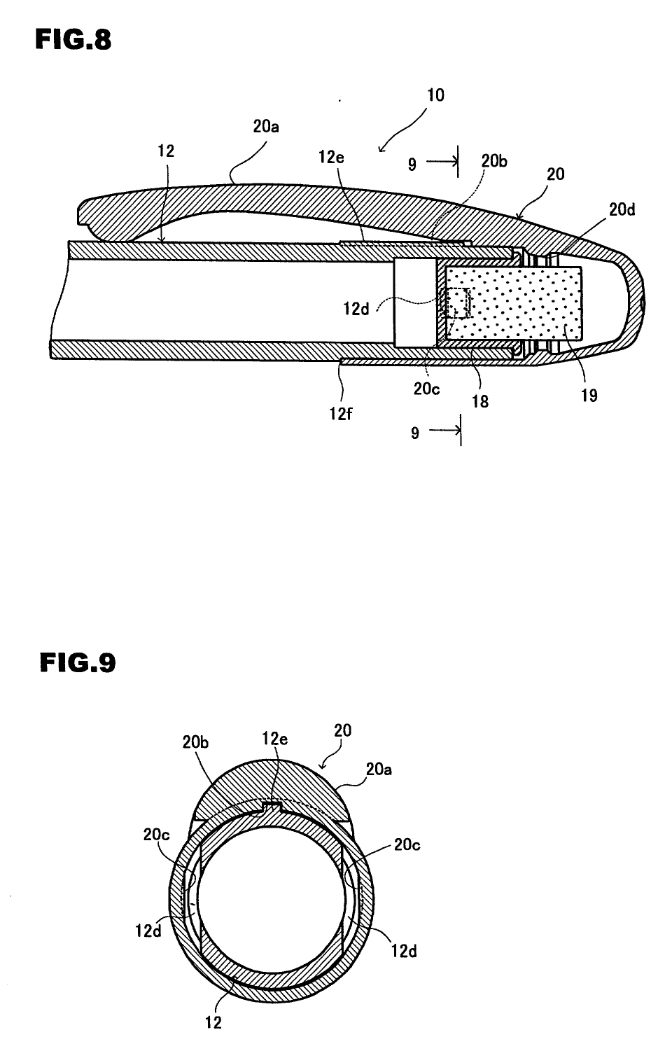

With the cap 20 fixed on the barrel 12, as shown in FIGS. 8 and 9, the longitudinal rib 12e on the barrel 12 is fitted in the slit 20b in the cap 20. Further, the protrusions 20c, 20c on the cap 20 are lightly engaged with the corresponding window holes 12d, 12d in the barrel 12, by which the tip end face of the cap 20 contacts the step face 12f of the barrel 12, thereby to regulate the tip end position of the cap 20. Since the longitudinal rib 12e and the slit 20b are located on the back face side of the clip 20a, they are not exposed conspicuously to the surface side, so that the writing instrument's appearance is not marred. Further, since the protrusions 20c, 20c and the window holes 12d, 12d with which the protrusions 20c, 20c are lightly engaged are hidden in the cap 20, the appearance is not marred. Incidentally, in the embodiment, the portion at which the longitudinal rib 12e is fitted in the slit 20b is previously set so as to be aligned in the circumferential direction with the position at which the protrusions 20c are engaged with the window holes 12d.

When leads are to be replenished or the eraser 19 is to be used, the cap 20 is pulled straight out of the barrel 12, such that the protrusions 20c, 20c disengage from the window holes 12d, 12d, so that the cap 20 can be removed from the barrel 12.

When the cap 20 is to be mounted again on the barrel 12, the cap 20 is moved so that the circumferential positions of the clip 20a or the slit 20b and the longitudinal rib 12e on the barrel 12 coincide with each other while using the clip 20a as a guide or directly viewing the slit 20b, such that the circumferential positions of the slit 20b and the longitudinal rib 12e on the barrel 12 can be aligned easily with each other. Therefore, the user can fix the cap 20 on the barrel 12 without missing the circumferential position of the slit 20b. Moreover, even if the circumferential position of the slit 20b somewhat shifts from that of the longitudinal rib 12e, the taper portion 20b1 formed at the tip end of the slit 20b in the cap 20 smoothly introduces the longitudinal rib 12e into the slit 20b.

While the two protrusions 20c, 20c and the two window holes 12d, 12d are provided in the first embodiment, the number of the protrusions 20c, 20c and the window holes 12d, 12d is not limited to two, and at least one protrusion 20c and at least one window hole 12d may be provided.

As described above, with this embodiment, the cap 20 can be mounted on the barrel 12 while viewing the slit 20b from the outside or using the clip 20a as a guide, so that the mounting operation is easy. On the other hand, the portion where the longitudinal rib 12e is fitted in the slit 20b is not visible easily from the outside due to the presence of the clip 20a, so that the writing instrument's appearance is not marred.

Further, the axial lengths of the slit 20b and the longitudinal rib 12e can be made relatively long, so that the fitting force therebetween can be stabilized. This construction provides a much higher fitting force than the engagement of an inclined engaging portion with a receiving portion as in the conventional construction. By properly forming the relationship between the width of the slit 20b and that of the longitudinal rib 12e, a proper (e.g., moderate) fitting force, which is not too high and not too low, can be provided.

Additionally, the protrusions 20c, 20c are lightly engaged with the window holes 12d, 12d, so that the fitting force can be stabilized further. In particular, by causing the position, at which the longitudinal rib 12e is fitted in the slit 20b, to be previously set so as to be aligned in the circumferential direction with the position at which the protrusions 20c are engaged with the window holes 12d, the fitting force can be stabilized even more.

Second Embodiment

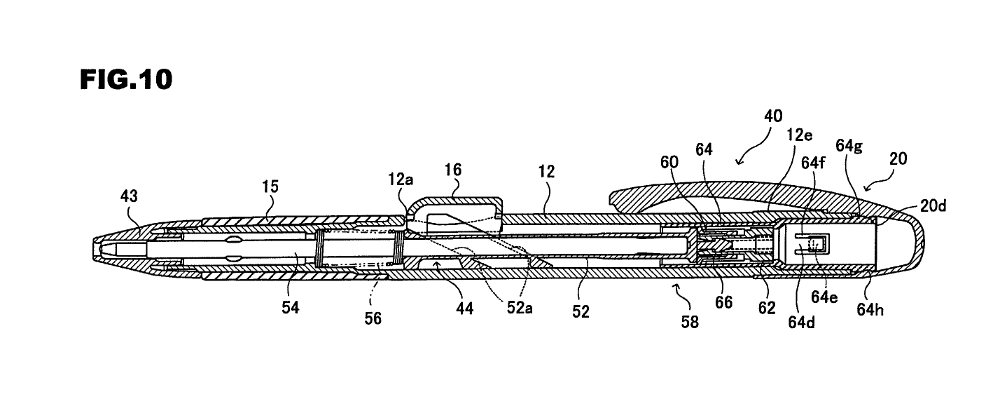

FIG. 10 shows a second embodiment in which a fixing construction for a barrel and a cap in accordance with the present invention is applied to a ball-point pen.

In FIG. 10, a side knock type ball-point pen 40 mainly includes a barrel 12, a refill feeding mechanism 44 disposed in the barrel 12, a knock operating portion 16 attached swayably to an opening 12a formed at a side central portion of the barrel 12, and a cap 20 fixed undetachably to the rear end of the barrel 12. At the tip end of the barrel 12, there is provided a tip-end element 43 which is screwed (e.g., threaded) in the body of the barrel 12. A rubber gripper 15 is fitted around the outer peripheral portion of the barrel 12 which positionally corresponds to a portion which is to be gripped by the user. The same reference numerals are applied to the elements similar to those in the first embodiment. It is noted that a considerable number of elements excluding the feeding mechanism can be used commonly for the mechanical pencil and the ball-point pen.

The refill feeding mechanism 44 includes a refill holder 52 provided with a cam portion 52a for being advanced in the axial direction by a swaying operation of the knock operating portion 16, a refill 54 having a rear end portion which is housed in the refill holder 52, a return spring 56 for urging the refill holder 52 rearwardly, and a rotating cam mechanism 58.

The rotating cam mechanism 58 includes a first rotating cam element 60, a second cam element 62, a cam body 64, and a spring 66. The rear end portion of the refill holder 52 is pressed in the tip end portion of the second cam element 62.

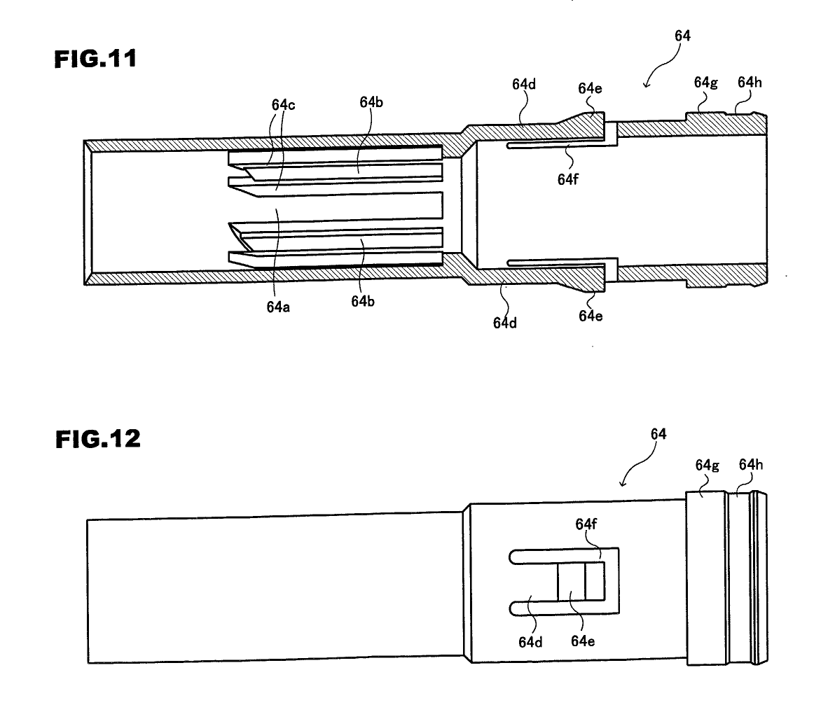

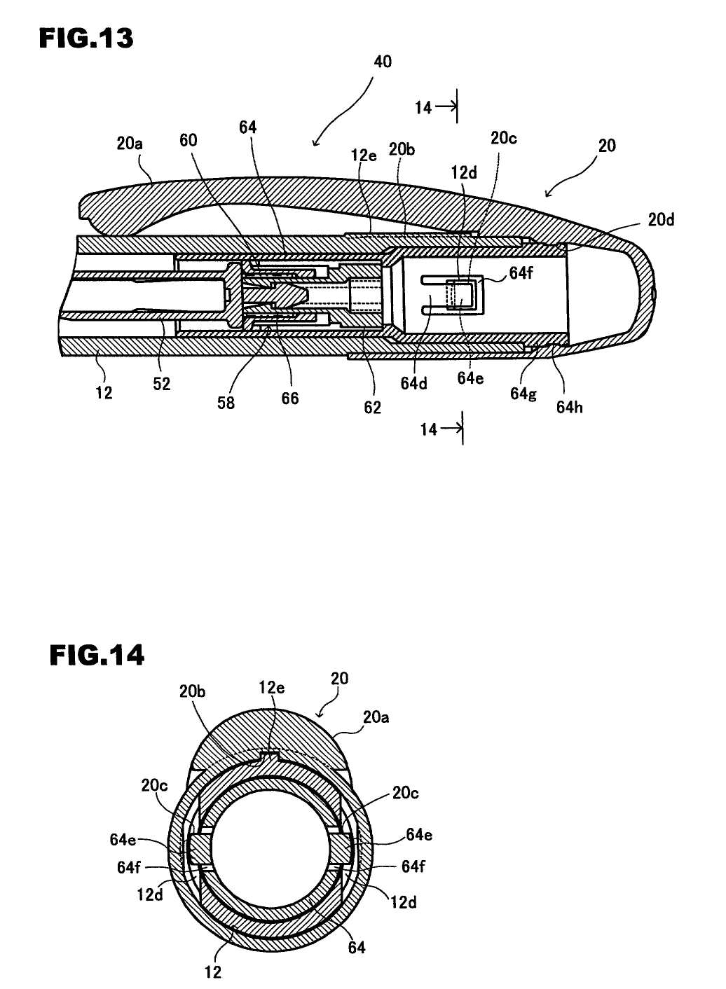

As shown in FIG. 11, in the inner peripheral surface of the cam body 64, deep grooves 64a and shallow grooves 64b are formed alternately in the circumferential direction via ridges 64c disposed therebetween. The second cam element 62 is disposed unrotatably in the cam body 64, and the tip end portion thereof is formed with a plurality of cam faces engaging the first rotating cam element 60. The first rotating cam element 60 is formed with at least one projecting portion (not shown), for being inserted in any one of the deep grooves 64a in the cam body 64 and incapable of being inserted in the shallow grooves 64b. The spring 66 is disposed between and urges the first rotating cam element 60 and the second cam element 62 in the direction such that they are always separated from each other, and a spring force of the spring 66 is set to be weaker than that of the return spring 56.

When the circumferential position of the projecting portion (not shown) of the first rotating cam element 60 coincides with the deep groove 64a, the projecting portion of the first rotating cam element 60 is inserted into the deep groove 64a and the first rotating cam element 60 is retracted by the urging forces of the return spring 56 and the spring 66.

Therefore, the refill holder 52 is also located at the retreat position, and the tip end of the refill 54 is retreated from the tip end of the tip-end element 43 (the state shown in FIG. 10).

On the other hand, when the knock operating portion 16 is knocked, the cam portion 52a is subjected to the swaying operation of the knock operating portion 16, whereby the refill holder 52 is advanced. Therefore, the second cam element 62, connected to the refill holder 52, is advanced. The advance of the second cam element 62 pushes the first rotating cam element 60 forwardly, such that the projecting portion of the first rotating cam element 60 is disengaged from the deep groove 64a. Simultaneously, the cam faces of the second cam element 62 rotate the first rotating cam element 60 in the predetermined direction with resort to the action of the spring 66, the projecting portion of the first rotating cam element 60 is then locked to the tip end portion of any one of the shallow grooves 64b, and the first rotating cam element 60 is held at the advanced position. Therefore, the refill holder 52 is also located at the advanced position, and the tip end of the refill 54 projects from the tip end of the tip-end element 43. The detailed description of the mechanism and operation of this rotating cam mechanism is omitted because it is well known.

On the outer peripheral surface at the rear part of the cam body 64, a pair of elastic members 64d are disposed approximately 180° apart from each other in the circumferential direction. Specifically, each of the elastic members 64d is formed such that three sides thereof are surrounded with a slit 64f so that the elastic member 64d can be displaced elastically in the radial direction. An elastic protrusion 64e is formed on the outer face at the tip end of each of the elastic members 64d. The elastic protrusion 64e engages the corresponding one of the window holes 12d, 12d in the barrel 12. While the pair of the elastic members 64d are provided in the embodiment, at least one elastic member 64d may be provided.

During assembly, the cam body 64 is inserted from the rear of the barrel 12, and the cam body 64 is moved within the barrel 12 until the elastic protrusions 64e of the elastic members 64d reach the window holes 12d while pressing the elastic members 64d in the inside diameter direction by utilizing the elasticity of the elastic members 64d. After the elastic protrusions 64e reach the window holes 12d and engage the window holes 12d, the cam body 64 will not detach from the barrel 12 inadvertently.

At the rear end portion of the cam body 64 is formed an extending portion 64g projecting from the rear of the barrel 12 when attached to the barrel 12. The extending portion 64g is formed with an annular concave portion (engaging portion) 64h. The annular concave portion 64h is configured so as to engage the annular protrusion 20d on the cap 20.

As in the first embodiment, the longitudinal rib 12e on the barrel 12 is fitted in the slit 20b in the cap 20, and the protrusions 20c, 20c thereof are lightly engaged with the window holes 12d, 12d in the barrel 12 together with the elastic protrusions 64e, 64e. Further, the annular protrusion 20d of the cap 20 is firmly engaged with the annular concave portion 64h in the cam body 64, by which the cap 20 is installed undetachably to the barrel 12 via the cam body 64.

In addition to having the advantages described above with regard to the first embodiment, the second embodiment also has the following advantages.

That is, although the cap 20 must be detachable from the barrel 12 to replenish leads and to use the eraser in the first embodiment in which the present invention is applied to a mechanical pencil, in the second embodiment in which the present invention is applied to a ball-point pen, it is more preferable that the cap 20 be undetachable from the barrel 12 because the refill 54 can be exchanged by unscrewing the tip-end element 43 from the barrel 12. Therefore, by fixing the cap 20 to the cam body 64 attached to the barrel 12 by utilizing the window holes 12d in the barrel 12, the cap 20 can be fixed firmly on the barrel 12 via the cam body 64.

Thus, the barrel 12 and the cap 20, commonly employed for the first embodiment, can be used for the second embodiment. Thus, the manufacturing cost, the cost required for parts management, and other costs can be decreased. Although the slit 20b is formed in the cap 20 and the longitudinal rib 12e fitted in the slit 20b is provided on the barrel 12 in the above-described embodiments, the construction is not limited thereto. Hence, a structure in which the slit 20b is formed in the barrel 12 and the longitudinal rib 12e is provided on the cap 20 is also possible.

Similarly, although the window holes 12d are formed in the barrel 12 and the protrusions 20c lightly engaging with the window holes 12d are provided on the cap in the above-described embodiments, the construction is not limited thereto. Thus, a structure in which the window holes are formed in the cap 20 and the protrusions 20c are provided on the barrel 12, is possible.

As described above, according to the present invention, since the slit 20b is visible to a user or a worker, the operation for mounting the cap 20 on the barrel 12 can be performed easily.

While the invention has been described in terms of several preferred embodiments, those skilled in the art will recognize that the invention can be practiced with modification within the spirit and scope of the appended claims.

what is claimed is:

1. A cap fixing construction for fixing a cap on a barrel of a writing instrument, comprising:
a slit formed in one of said barrel and said cap and extending in an axial direction from an end of said one of said barrel and said cap; and
a longitudinal rib formed on the other of said barrel and said cap and extending in the axial direction, such that said cap is fixed on said barrel by fitting said longitudinal rib in said slit.

2. The cap fixing construction according to claim 1, further comprising a clip formed integrally with said cap and extending from a peripheral surface of said cap to said barrel,
wherein a position where said longitudinal rib is fitted in said slit is arranged on a back face side of said clip.

3. The cap fixing construction according to claim 1, further comprising at least one window hole formed in a peripheral surface of one of said barrel and said cap, and at least one protrusion provided on the other of said barrel and said cap, wherein said at least one protrusion is engaged with said at least one window hole.

4. The cap fixing construction according to claim 3, wherein the engagement position of said at least one protrusion with said at least one window hole is aligned with a fitting position of said longitudinal rib in said slit in a circumferential direction of said barrel and said cap.

5. The cap fixing construction according to claim 1, further comprising an engaged portion formed on an inside surface of said cap for engaging an engaging portion formed at a part of an internal mechanism projecting from the end of said barrel.

6. The cap fixing construction according to claim 1, further comprising:
an extending portion of an internal mechanism incorporated in said barrel, said extending portion projecting from the end of said barrel;
an engaging portion formed at the projected extending portion; and
an engaged portion formed on an inside surface of said cap and firmly fitting to said engaging portion.

7. The cap fixing construction according to claim 6, further comprising at least one window hole formed in said barrel, and at least one elastic protrusion, which is engaged with said at least one window hole and for being elastically displaced in a radial direction, being formed at a part of said internal mechanism.

8. The cap fixing construction according to claim 2, further comprising at least one window hole formed in a peripheral surface of either one of said barrel and said cap, and at least one protrusion provided on the other of said barrel and said cap, wherein said at least one protrusion is engaged with said at least one window hole.

9. The cap fixing construction according to claim 2, further comprising an engaged portion for engaging an engaging portion formed at a part of an internal mechanism projecting from the end of said barrel, said engaged portion being formed on an inside surface of said cap.

10. The cap fixing construction according to claim 3, further comprising an engaged portion for engaging an engaging portion formed at a part of an internal mechanism projecting from the end of said barrel, said engaged portion being formed on an inside surface of said cap.

11. The cap fixing construction according to claim 4, further comprising an engaged portion for engaging an engaging portion formed at a part of an internal mechanism projecting from the end of said barrel, said engaged portion being formed on an inside surface of said cap.

12. The cap fixing construction according to claim 2, further comprising:
an extending portion of an internal mechanism incorporated in said barrel, said extending portion projecting from the end of said barrel;
an engaging portion formed at the projected extending portion; and
an engaged portion formed on an inside surface of said cap and firmly fitting to said engaging portion.

13. The cap fixing construction according to claim 3, further comprising:
an extending portion of an internal mechanism incorporated in said barrel, said extending portion projecting from the end of said barrel;
an engaging portion formed at the projected extending portion; and
an engaged portion formed on an inside surface of said cap and firmly fitting to said engaging portion.

14. The cap fixing construction according to claim 4, further comprising:
an extending portion of an internal mechanism incorporated in said barrel, said extending portion projecting from the end of said barrel;
an engaging portion formed at the projected extending portion; and
an engaged portion formed on an inside surface of said cap and firmly fitting to said engaging portion.

15. A cap fixing construction for fixing a cap on a barrel of a writing instrument, comprising:
a groove formed in one of said barrel and said cap and extending in an axial direction from an end of said one of said barrel and said cap; and
a longitudinal projection formed on the other of said barrel and said cap and extending in the axial direction, such that said cap is fixed on said barrel by fitting said longitudinal projection in said groove.

16. The cap fixing construction according to claim 15, further comprising a clip formed integrally with said cap and extending from a peripheral surface of said cap to said barrel,
wherein a position where said longitudinal projection is fitted in said groove is arranged on a surface of said clip facing said cap.

17. The cap fixing construction according to claim 15, further comprising at least one window formed in a peripheral surface of one of said barrel and said cap, and at least one protrusion provided on the other of said barrel and said cap, wherein said at least one protrusion is engaged with said at least one window hole.

18. The cap fixing construction according to claim 17, wherein the engagement position of said at least one protrusion with said at least one window is aligned with a fitting position of said longitudinal projection in said groove in a circumferential direction of said barrel and said cap.

19. The cap fixing construction according to claim 15, further comprising an engaged portion formed on an inside surface of said cap for engaging an engaging portion formed at a part of an internal mechanism projecting from the end of said barrel.

20. The cap fixing construction according to claim 15, further comprising:
an extending portion of an internal mechanism incorporated in said barrel, said extending portion projecting from the end of said barrel;
an engaging portion formed at the projected extending portion; and
an engaged portion formed on an inside surface of said cap and firmly fitting to said engaging portion.
